(19) United States
(12) Patent Application Publication
(10) Pub. No.: US 2012/0159336 A1
(43) Pub. Date: Jun. 21, 2012

(54) ELECTRONIC LIST PRIORITY MANAGEMENT SYSTEM AND METHOD OF USING SAME

(76) Inventor: Michael Roy Norwood, Sedona, AZ (US)

(21) Appl. No.: 13/406,483

(22) Filed: Feb. 27, 2012

Related U.S. Application Data
(63) Continuation-in-part of application No. 12/749,452, filed on Mar. 29, 2010.
(60) Provisional application No. 61/164,186, filed on Mar. 27, 2009.
(60) Provisional application No. 61/217,684, filed on Jun. 3, 2009.
(60) Provisional application No. 61/446,637, filed on Feb. 25, 2011.

(51) Int. Cl. G06F 3/048

(52) U.S. Cl. 715/733; 715/810

(57) ABSTRACT

An electronic list prioritization system for the improved management, sorting and prioritizing of list items is described. The system comprises a computer program that a user may interface on any suitable electronic device. The user may prioritize list items with a number of advance prioritization features describe. The list may be a task list having a task field and in some embodiments a primary and secondary priority field allowing the user the ability to prioritize a list by a secondary priority field without adjusting the priorities in the primary priority field.

### CROSS REFERENCE TO RELATED APPLICATIONS

This application is a continuation in part of U.S. patent application Ser. No. 12/749,452, entitled ‘Simplified User Interface and Method for Computerized Task Management Systems’, filed on Mar. 29, 2010; Ser. No. 12/749,452 in turn claimed the benefit of U.S. provisional patent application 61/164,186 filed Mar. 27, 2009; and U.S. provisional patent application 61/217,684, filed on Jun. 3, 2009; this application also claims the benefit of U.S. provisional patent application No. 61/446,637 filed on Feb. 25, 2011, all of which are incorporated herein by reference.

### BACKGROUND OF THE INVENTION

1. Field of the Invention

The invention relates to computer programs and computerized methods that provide user interfaces and methods for computer systems, in particular database management systems such as project management systems, task management systems, email lists and other types of computerized list and collaboration systems. The present invention relates more specifically to computer programs and computerized methods that provide user interfaces and methods to allow a user or users to prioritize and edit or reprioritize an electronic list by utilizing, editing, sorting and configuring priority numbers for setting the priority of a list item or list items.

2. Background

There are any number of electronic list types that users interface with through an electronic display, such as email lists, electronic data lists including music or video lists, and task management lists. Many of these electronic lists can become very long and difficult to manage. In addition, there exists a need for a way to more effectively and efficiently prioritize and manage these lists and to sometimes limit what is viewed to a more manageable, less overwhelming number of list items. More specifically, computer programs are often used for project management wherein a number of team members interface with the program to determine team and individual priorities. These priorities often change and new tasks are routinely required to be added and/or deleted from the task list. Managing and editing these task lists can be complicated, confusing, time consuming and overwhelming.

In addition, it is beneficial for team members to communicate the status of tasks and to provide communication to other team members throughout the project. With most task management software systems, communication between team members requires the opening of additional windows, which take the team members away from the main task list display. In other cases, communication between team members is done through a secondary communication system, such as through email or over the phone which creates multiple systems for the team members to keep track of, and does not adequately keep all team members informed of key updates and relevant information.

### BRIEF SUMMARY OF THE INVENTION

The invention is based, in part, on the insight that there exists a need for a new type of list item and task prioritization system to help with a major problem nearly everyone in modern society is facing nowadays, which is information overload.

Although one cause of this information overload is the non-stop inundation of messages and media coming at us primarily through our computers and mobile electronic devices, another cause of this information overload is the inefficiency of prior art systems to prioritize the individual items in this incoming flood of information.

When prioritization systems are inadequate people simply don't know what they need to do next. This can result in stress, frustration, lowered productivity and exhaustion.

Prior art prioritization systems for actionable lists of any kind were commonly based on classification or categorization of the various list items as to “Non-Critical, Moderately Critical and Critical” for importance, and “Today, Tomorrow, This week, Next Week” (or similarly entitled categories) for urgency. These prior art systems, because of their limited number of categories, tended to lack flexibility and often could result in their users having so many items in a particular category, that it would render the entire purpose of that prioritization category nearly useless.

For example, if over time you build up 100 items on a to-do list or project list, if 33 of these items are listed as “critical” (or, in other systems, put in for example the “today” category) that still leaves those 33 tasks un-prioritized within that category. Which task within that category should come first? Which second? Which third?

There is thus a great need for a system flexible enough to easily and quickly prioritize any number of new or existing list items to any desired position of importance in a list.

Previous work in parent U.S. patent application Ser. No. 12/749,452, incorporated herein by reference, discussed a simplified user interface and method for computerized task management systems that used some improved numeric prioritization methods to simplify task management. The present application builds on this foundation, and further discloses various improved priority management methods that can also be used for other types of list based systems, such as email lists, movie lists, or any type of list.

The invention is based in part on the observation that even with systems where there is a very large or even infinite number of prioritization categories (e.g. an infinite number of different priority numbers), in real life, users still tend to overuse the priority of “1” on many tasks. This is because most of us, due to the limitations of the human mind, have the natural tendency to think that each new task that we record is the most important one we need to do next. In reality of course, we usually can do only one or a few tasks at a time, and thus ranking multiple tasks as “1” is thus unrealistic and indeed counterproductive.

The present invention is designed to help overcome the natural weakness of the human mind to rank new tasks as “1”, which is also a weakness of prior art prioritization systems. This can be done by making it easier for users to adjust the priority of various list items.

The invention is also based, in part, on the insight that there exists a need for a computer program based electronic list priority management system with a simplified user interface. In particular, there is a need for a simplified user interface that simplifies the method of adding or deleting list items, editing list item priorities, or sorting list item priorities by factors including due date, assigned date, task name and the like.

The invention is also based, in part in the insight although teams of users often communicate priorities through the use of computer interfaces, there exists a need for user interfaces that provides a user with a separate prioritization ranking for various items that may be different from the overall team prioritization ranking for these items. In addition, there exists a need for a user interface that allows for the efficient communication between team members that keeps the team members engaged and interacting with electronic priority lists.

The invention is directed to computer programs that provide user interfaces and methods for operating computer systems, in particular database management systems such as email lists, project management systems, task management systems, list systems of any kind, and other types of computerized collaboration systems using these programs, and specifically for manipulating the priority of various items on these systems.

Thus in some embodiments, the invention may be a method of operating a computerized user priority interface. This method may comprise automatically limiting the range of available priority inputs for the user, so that, given a plurality of items, a user may only enter a highest priority value for only one item.

The invention may further provide a user entered priority limitation range so that the user may enter a lower bound priority number, and a higher bound priority number, and a priority limitation “cap” or maximum value “n” so that only “n” items from the plurality of items may be assigned the same priority number.

The invention may further provide a method to automatically provide numeric gaps or spaces between the previously user assigned priority numbers, such that each previously assigned user priority number “x” is multiplied by a spacer number “y”, thereby changing each previously assigned priority value x to a new value x*y, thereby creating integer numeric gaps between previously assigned priority numbers so that new priority numbers may be assigned with values between these gaps.

The invention may further provide a method to allow a user to select a set of items from a plurality of items, and allow the user to automatically reassign the priority numbers of each item from the selected set of items to a new priority number.

The invention may further provide a method to automatically provide a default priority value that will be assigned to items newly entered to said plurality of items.

The invention may further provide a method to allow a user to automatically select an item from a list comprising a plurality of items, insert a new item above or below said selected item in said list, and either automatically provide a priority number for the new item, or allow the user to manually assign a priority number to the new item.

The invention may further provide a method to allow a user to designate a item from a list of items to move up (promote) or down (demote) in priority, move the position of the list in the user interface, and automatically reassign the priority number of the designated item according to if the item has promoted or demoted.

The invention may further provide a method to assign both a primary (public) priority field and a secondary (private) priority field to one or more items in a plurality of items, whereby a user may optionally sort the items according to the secondary (private) priority field without disturbing the primary (public) priority ranking of the one or more items.

The invention may further provide a method to automatically update the priority values of one or more items in a plurality of items whenever items are added or deleted from the plurality of items.

### BRIEF DESCRIPTION OF THE DRAWINGS

FIG. 1 shows a schematic view of the electronic list priority management system described herein having the computer program described herein loaded on a database and connected through a network to a plurality of users' electronic devices.

FIG. 2A shows a working display comprising an electronic list having a priority field.

FIG. 2B shows a working display of the electronic list shown in FIG. 2A after the priority limitations feature has been selected.

FIG. 3A shows a working display of an electronic list having a pop-up window with a priority spacer feature selection display.

FIG. 3B shows a working display of the electronic list shown in FIG. 3A after the priority spacer feature has been selected (with a spacing of “10”).

FIG. 4A shows a working display of an electronic list having a pop-up window with a priority definer feature selection display.

FIG. 4B shows a working display of the electronic list shown in FIG. 4A after the priority definer feature has been selected.

FIG. 4C shows a working display of the electronic list shown in FIG. 4A after the priority definer feature has been selected, and a priority limitation is activated.

FIG. 5A shows a working display of an electronic list having a priority shortcut feature pop-up window with a priority shortcut feature selection display.

FIG. 5B shows a working display of the electronic list shown in FIG. 5A after the priority shortcut feature has been selected.

FIG. 6A shows a working display of an electronic list having a personal priority feature having a secondary priority field.

FIG. 6B shows a working display of the electronic list shown in FIG. 6A after the electronic list has been sorted by the personal priority field.

FIG. 7A shows a working display of an electronic list having a priority an electronic list having two list items selected for deletion.

FIG. 7B shows a working display of the electronic list shown in FIG. 7A after the two selected list items have been deleted without the priority re-distribution feature selected.

FIG. 7C shows a working display of the electronic list shown in FIG. 7A after the two selected list items have been deleted with the priority re-distribution feature selected.

### DETAILED DESCRIPTION OF THE INVENTION

Before proceeding with the detailed description of the invention, a few definitions are in order.

### DEFINITIONS

“Electronic device”, as used herein, is any electronic device that has the means to receive and run the computer program, as described herein, and has at least one display or is connected to at least one display, such as a computer connected to a monitor.

“Computer program”, as used herein, is defined as any electronic data that may be read by an electronic device for the purpose of displaying an electronic list as described herein. A computer program may be adapted for computers, or for smart phones, and may be application software. In addition, a computer program may be used with an electronic list that is derived from a second computer program. A computer program as used herein may have any suitable number of sub-programs for performing the functions of the system as described.

This computer program, or a portion of the computer program may be provided to users on a computer readable medium such as a disc or any other suitable data storage device, or downloaded from a network such as the Internet. The program may also be downloaded from a database to a plurality of users. The program, or a portion of the program, may be downloaded to a plurality of users and a portion of the program may be on a database that is interfaced with the plurality of users through a computer network. Any suitable network and database may be used, such as a local network and/or database. For example, a company may have a local network and database that is only accessed by employees, thereby increasing security of the system. The internet and any suitable database or databases may also be used by any number of users for the invention.

“Selecting”, as used herein, is the act of interfacing with an electronic device to select any of the features of the computer program and includes, but is not limited to, clicking a mouse oriented icon on the display, “point and click” actions, touch screen manipulation, voice activation, keyboard input and the like, and any combinations thereof.

“Working display”, as used herein, is defined as the image displayed by the computer program on an electronic device display.

“Continuous work display”, as used herein, means that the work display does not require the opening of any separate windows throughout the full functioning of the program. A user can interact with the electronic list priority management system described herein in one open window that may have window expansion features or pop-ups.

“Advance priority management feature”, as described herein, is any priority feature that when selected results in the changing of a plurality of list item priority numbers and consists of a priority limitation feature, priority spacer feature, priority definer feature, a priority default feature, a priority insert feature, a priority shortcut feature, a personal priority feature or secondary priority feature, and a priority re-distribution feature.

“User interface display”, or “electronic display”, is referred to as simply a display throughout the current specification. In addition, for simplicity, electronic list is referred to as a list, throughout the current specification

“Electronic list item”, as used herein, is a configured display on a display and comprises at least one priority number field and at least one associated field. In one embodiment, the electronic list item comprises a plurality of associated fields as described herein.

Any number of fields may be associated with an electronic list item, such as more than two, more than five, more than ten more than twenty, more than fifty and any range between and including the quantities provided.

“Displayed list”, as used herein, is the electronic list that is shown on the working display and may comprise only a portion of the entire list. In one embodiment, a user may select or input the number of list items that are displayed on the working display at any time. In addition, a user may opt to see additional list items by selecting an additional page feature, whereby additional list items are shown on the working display. In another embodiment, a user may scroll the list, such as up or down, within the working display to view additional list items, or from side to side to view additional fields

“Field”, as used herein, is defined as a category associated with a list item that is displayed in a representative way, with a list item and has a field header.

“Task list”, as used herein, is defined as an electronic list having at least one priority field, and a task field, where the task field identifies a task by name number or other characters. A task list may comprise any number of other fields including the task creator's name, a primary and secondary priority, a project name, assignment name including a person or team, a percent complete, completed hours, total hours, assigned date, due date, expected date, completed date, and the like.

“Prioritization”, as used herein in reference to the electronic list, means that the list items' priority numbers may be edited or changed through an interface by a user.

“User interface feature”, as used herein, is defined as any feature a user may use to interface with the computer program through an electronic device and/or auxiliary components, such as a mouse or keyboard, and includes, but is not limited to, a selecting feature, a data input feature, a drag and drop feature, a sort by column feature, an in-line editing feature, and a hierarchy of sorting feature, or any combination thereof.

### Discussion:

Because the invention's various methods and techniques are generally intended to be run on computerized systems comprising at least a processor, memory, user interface, and typically a network connection, the invention may often be discussed in the alternative as a computer program or type of computer program.

The electronic list priority management system described herein comprises a computer program that provides a user interface for an electronic display comprising a plurality of list items wherein each list item has associated fields including at least one priority field, and at least one other field, and may have any number of additional associated fields. Some of the additional associated list item fields include, but are not limited to, list item creator name, comments, selection field, attachments, attachment size, list item emailed date, a secondary priority, a project name, assignment name including a person or team, a percent complete, completed hours, total hours, assigned date, due date, expected date, completed date, and the like.

The computer program described herein may provide a user interface to expand, edit or comment on any of the list item fields described herein. For example, each list item has at least one associated priority field and a user may interface with this field by clicking on the field and editing the priority number. The computer program may then automatically change the position of the list item in the item list. In another embodiment, a user may expand a list item field by selecting the list item field by clicking on or by “mousing over” the field, whereby a pop-up window associated with the field provides more detailed or historical information, for example. For example, a list item may have a comment field, whereby a user may click on the latest comment entered into the field or an associated button to open a pop-up having the comment history for that list item. A user may simply add a comment by clicking on the comment field and inputting a new comment. In some embodiments, only a portion of the associated list item field activates the pop-up window. The pop-up window allows the user to see additional information related to a task field without leaving the working display of the task management system. A pop-up window or an expanded list item field window display may be contiguous with the field display or may be located in any suitable location on the display. In some embodiments, an expanded list item field window display may be in a location on the display whereby the user can still see other important list items, or the entire displayed list.

The computer program described herein may have any number of different options and setting interfaces for the user, list manager or task manager. For example, a list item number display feature may be provided, whereby a user may choose or select the number of list items to be shown on the display at a time. Displayed list, as used herein, is the item list or portion of the item list that is shown on the working display. In addition, a user may select to see additional list items by selecting a page feature, whereby additional list items are shown on the working display. The page feature may be used in conjunction with the list item number display feature, to show the next quantity of list items corresponding to the list item number selected. In addition, the page feature may comprise a page up and page down icon display for user selection. In another embodiment, a user may scroll the list, such as up or down within the working window to view additional list items, or from side to side to view additional fields.

The computer program described herein may comprise a drag-and-drop interface feature, whereby a user may move a list item by selecting it and sliding it to a new position, such as up or down within the list. A user may select a single list item or a plurality of list items for moving with the drag and drop feature. In some embodiments, the list item or item's priority number may be automatically updated as a function of the change in position within the list. When the priority number of one list item is changed using the drag-and-drop feature, then the priority numbers of all other list items may update accordingly.

The computer program described herein may comprise a list item field sorting feature, whereby a user may sort the list by any of the specific list item fields, such as list item creator name, first priority, secondary priority, project name, percent complete, completed hours, total hours, assigned date, due date, expected date, completed date, team member name and the like.

The computer program described herein may comprise an in-line editing feature, whereby a user may edit priorities and the list order is automatically rearranged as a function of the edited priorities. For example, a user may select a list item having a priority of “5” and change that priority to “1”, whereby the edited list item is moved to the top of the list and list items previously having priorities 1 through 4 are moved down one position on the list.

The computer program described herein may comprise a hierarchy or sorting feature, whereby a user may sort the list by any of the list item fields described herein and the priority of the list is automatically updated. For example, a user may click on the percent complete list item field header and the list may be arranged with the list item having the highest percent complete at the top of the list and the lowest percent complete on the bottom of the list. The system may have the priority field header as a hardcoded secondary default feature. Thus if 10 items have a percentage complete field inputted with a value of 1% or higher, and 10 items have a value of 0% (or have no value inputted by the user), then the first 10 list items inputted with percentages will be sorted by this percent column, and the second 10 list items without inputted percentages will be automatically sorted by the priority field. The computer program may comprise a list item field re-sorting feature, whereby a user may select a list item field header a second time to sort the field in the opposite order. For example, a user may select the percent complete list item field header and the list may be arranged with the highest percent complete list item at the top of the list. The user may then select the percent complete list item field header a second time to re-sort the list in the opposite order, with the lowest percent complete list item at the top of the list.

### Priority Limitation Feature

The computer program described herein may comprise a priority limitation feature, whereby a user may add or edit a list item and give it a new priority number and the computer program will automatically update the list order and each list item priority number. As previously discussed, many users may have the tendency to give many list items a priority of number “1,” or the highest priority setting. These users may have a list with two, three, four or many more number “1” priorities. This can be confusing and overwhelming to users as well as defeat the entire purpose of the prioritization system. The priority limitation feature would overcome this flaw by allowing for only one priority number “1” and would change a previous priority number “1” list item to priority “2” in the event that the user added a new list item with a priority number “1,” or edited an existing list item to priority number “1.” All list item priorities in the list may be updated when a user adds a new list item or edits an existing list item priority.

The priority limitation feature may further provide a user with an interface to select or input a priority limitation range, having a lower limitation priority number, an upper limitation priority number, and a priority limitation cap, whereby the list items between the lower limitation priority number and the upper limitation priority number can only have a number of list items with the same list item priority as the priority limitation cap. For example, a user may select a lower limitation priority number of “1”, and an upper limitation priority number of “5,” with a priority limitation cap of one, whereby the priority limitation feature will limit single priorities to priority numbers “1” through “5.” The user may then use the priority limitation feature to set another priority limitation range. For example, a user may select a lower limitation priority number of “6”, and an upper limitation priority number of “10,” with a priority limitation cap of three, whereby the priority limitation feature will limit list items having priority numbers of six through ten to three list items each. With these two ranges set by the user, the electronic list would allow a single priority list item for priorities “1” through “5” and as many as three list items with priority numbers of “6” through “10” each. Through this new priority limitation feature, creating an overwhelming number of list items with the same priority number is avoided, and the entire purpose of preventing user overwhelm by creating numeric list priorities is kept intact.

### Priority Spacer Feature

The computer program described herein may comprise a priority spacer feature, whereby a user may select any number of list items and increase their priority ranking by the product of the list item's priority number and the priority spacing number. For example a user may select list items with priority “1,” “2,” “3,” “4,” and “5,” and then select the priority spacer feature and select a spacing number, such as “10”, for example. The computer program may then automatically change the priorities of selected list items with priority ““1,” “2,” “3,” “4,” and “5,”, to a priority of “10,” “20,” “30,” “40,” and “50” respectively, thereby providing space or non-used priority numbers between the selected priorities. List items with priority numbers above the highest priority number selected list item would have updated priority numbers. For example, a list item with a priority of “6,” would have an updated priority of “51” after priority spacing in the above example. A list item with a priority of “10,” would have an updated priority of “55” after priority spacing in the above example. A list item with a priority of “15” would have an updated priority of “60” after priority spacing in the above example. Unselected list items would have updated priority numbers with the same priority difference to the nearest selected priority list item. This priority spacer feature provides the option of creating more space between list item priorities and may be used in place of, or in conjunction with the priority limitation feature described herein. The priority limitation feature may slow down database retrieval and display of list items if applied to too many list items (because the system has to recalculate every priority number of every list number to which priority limitation is applied). Thus, using the priority spacing feature in portions of a list where priority limitation is not applied will prevent the same problem that existed prior to this invention, whereby too many list items may have the same priority number.

### Priority Definer Feature

The computer program described herein may comprise a priority definer feature, whereby a user may select any number of list items and edit their priority number to a newly defined priority number as described hereafter. For example, a user may select list items with priority numbers “1,” “5,” and “10” and then select the priority definer option and select a definer number 20, whereby the selected list items would all be given a new priority number of “20” unless the user has also selected the priority limitation feature, whereby the selected list items would be given new priority numbers, “20,” “21,” and “22” respectively, when the priority limitation cap has been set to one. A list item with a priority number of “20” prior to the above example, would have an updated prior number of “21” after the priority definer function was performed with no priority limitation set for this range of priorities. A list item with a priority number of “20” prior to the above example, would have an updated prior number of “23” after the priority definer function was performed if having a priority limitation range set for this new number and having a priority limitation cap of one. This priority definer feature is invaluable as a form of “tagging” certain list items which the user wishes to keep together for easy classification. (This is the opposite reason of why the user would choose the priority spacing feature).

### Priority Default Feature

The computer program described herein may comprise a priority default feature, whereby a user may select a priority number to be assigned to all newly added list items. For example, a user may select the priority default feature and select a priority default number of “20,” whereby all newly added list items would be given the priority number of “20” unless a priority limitation range was also selected. For example, if a priority limitation range was set for this priority range and had a priority limitation cap of one, the most recently added list item would have a priority number of “20” and earlier added list items would have priority numbers of “21,” “22,” and so on. The priority default feature allows a user to input a plurality of new list items with the same priority number that may be edited at a later time. This feature serves the same invaluable purpose as the priority definer feature of creating a form of “tagging” certain list items that the user wishes to keep together for easy classification.

### Priority Insert Feature

The computer program described herein may comprise a priority insert feature, whereby a user may select a list item and subsequently select to insert a new list item above or below the selected list item. In one embodiment, a tab or some other display feature may pop-up when a list item is selected, and a user may select this tab or other display feature to add a new list item. For example, a user may select a list item by clicking on or otherwise selecting it, and the list item may be highlighted to show that it has been selected. In addition, a tab may pop-up above and/or below the list items after it has been selected. A user may subsequently select one of these tabs to add a new list item. The priority number of the newly added task may be inputted by the user, or when left blank, may be automatically provided by the computer program and may be the average priority number between the selected list item and the list item proximate the newly added list item. In some embodiments, a newly added task may have a priority number that is determined by the priority limitation feature described herein. In another embodiment, a tab or tabs may be shown at all times on the working display, such as in a portion of at least one list item field, or connected with at least one list item field. The priority numbers of list items may be automatically updated after the insertion of a newly added list item per the users selected features as described herein.

### Priority Shortcut Feature

The computer program described herein may comprise a priority shortcut feature, whereby a user may select a priority shortcut feature to move a list item or items up or down in priority. A priority shortcut feature may be an arrow or some other icon that indicates movement of the list items. For example, the shortcut feature may be displayed as an icon or icons when a list item is selected. Thus, a user may click on a single list item and move it up or down by subsequently selecting the priority shortcut feature. In another embodiment, a user may select a plurality of list items and move the selected group up or down collectively by selecting a priority shortcut feature. In yet another embodiment, a user may select a list item or items and then input a command through a keyboard, for example, to move a list item or items. For example, a user may select a list item and click on the up arrow on a keyboard to move the selected list item up one in the list order, or to a higher priority.

### Personal Priority Feature

The computer program described herein may comprise a personal priority feature, whereby the electronic list may comprise a secondary priority number field. This field may be used to set a personal or secondary priority to the list items without affecting the primary priority list. A user may sort the electronic list by the secondary priority field and may use any of the features described herein, including the advanced priority features. This personal priority feature enables a team member, for example, to resort a list of task items to the team member's own preference without disturbing the primary priorities of each task item inside a single project possibly viewed by many team members. This can be invaluable when the team member is viewing task items assigned to them personally from two or more separate projects. With this personal priority feature, the team member can make their own priority list of which tasks from which projects they need to do first, second, third, etc. However, without this secondary personal priority feature, if each team member was continually changing the primary priority numbers of each task item inputted by, for example, a project manager, there would be total flux and chaos of the priority sequence of tasks inside each project.

### Priority Re-Distribution Feature

The computer program described herein may comprise a priority re-distribution feature, thereby allowing the user to choose to have priority numbers automatically updated when priority numbers have been edited in any way, including adding, archiving or deleting a list item. The purpose of this priority re-distribution feature can be seen if the priority limitation had a priority limitation cap of 1 for the priority range of 1 to 10, and the user was additionally using the priority range “focusing feature” described in our previous patent application Ser. No. 12/749,452. If the user had the priority range focusing feature set to a range of 1 to 5, for example, then the user would be limited to seeing tasks with the priority numbers 1 to 5. If the user then archived the first 3 list items having the priorities numbers of 1, 2 and 3, the first item in the list would then become the previous fourth priority list item and its associated priority number 4. Thus, the user would only now be seeing only 2 list items on this page—the list items with priorities 4 and 5 (a mode which the user may prefer as it may give the user a feeling of accomplishment of visually seeing items getting completed and disappearing from that priority range of 1 to 5). However, with priority re-distribution, the user would continue to see 5 tasks on the page because the list items previously designated with priority numbers 4, 5, 6, 7 and 8 would then re-distribute to having the new priority numbers of 1, 2, 3, 4 and 5. This automatic re-distribution would allow the user to continue seeing a full 5 tasks on the page per the priority range focusing feature without having to spend the time manually changing the priority numbers of the higher-priority numbered list items. While not giving the user the same psychological satisfaction of seeing tasks getting completed and disappearing (per this one of numerous examples of priority re-distribution's use), it would save the user considerable time reprioritizing higher task priority items. The cumulative time savings over a period of days, weeks and months continually using this automatic priority re-distribution feature with task management would be considerable.

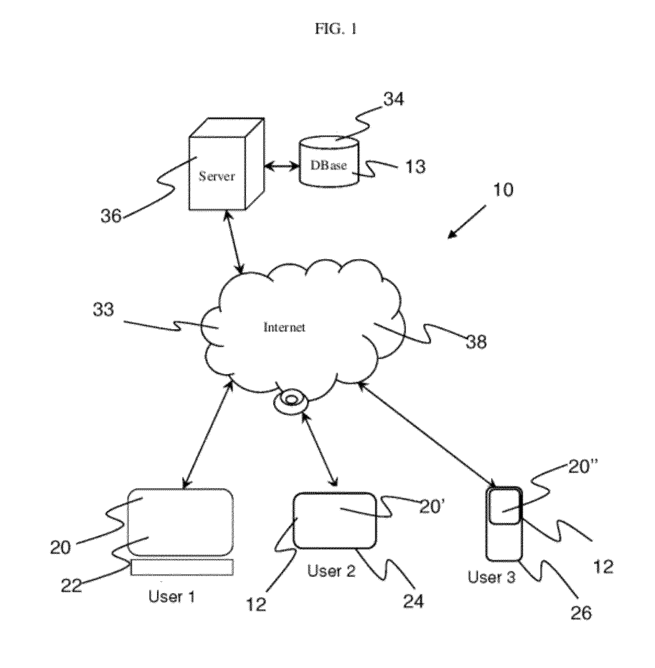

FIG. 1 shows an electronic list priority management system having a computer program 13 on a database 34, that is connected to a plurality of electronic devices through a server 36 and network 33. Any suitable configuration of components to enable the computer program to interface with users may be used. A database may be connected to an electronic device through any suitable means, including through ethernet wire, coaxial cable, fiber optic cable, wirelessly or any combination thereof. Three different electronic devices are shown in FIG. 1: a computer 22, a tablet computer 24 and a smart phone 26. Any electronic device having the means to receive and process or execute a program, and having a display, may be suitable for use with the electronic list priority management system described herein. A plurality of users may interface with each other and share information through the electronic list priority management system described herein. For example, one user may update an electronic list priority and other users may be able to see and act according to the new priority list. In addition, users may input data into the electronic list priority management system described herein, and this new data, including a new list item, an input to a list item field, or a comment input, may be viewed by other users on their electronic displays.

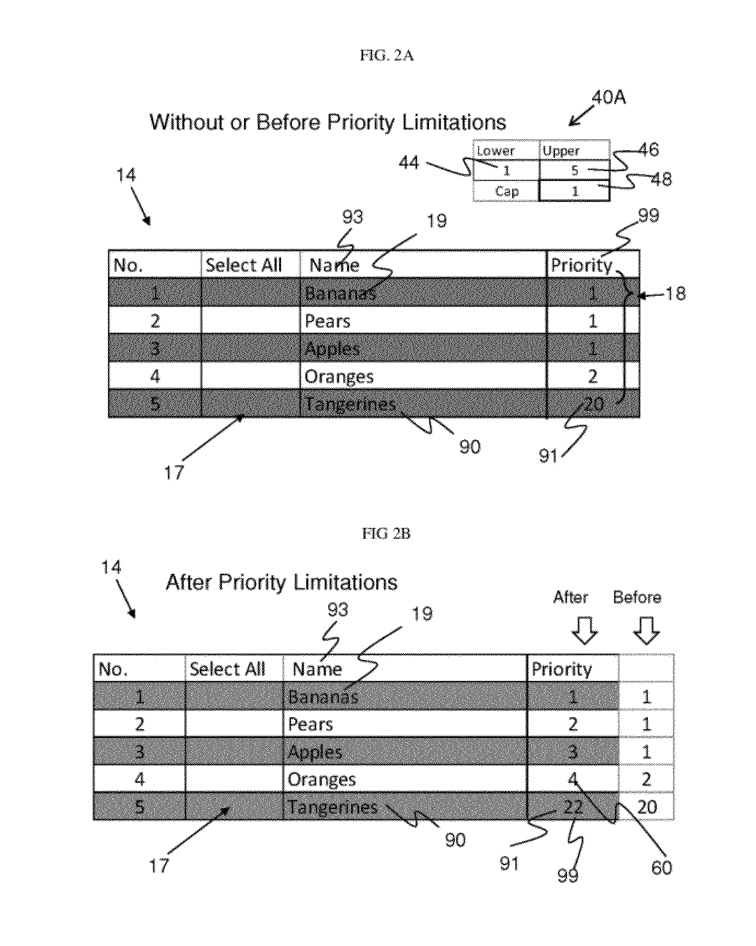

FIG. 2A shows a working display having five list items, with three of the list items having a number “1” priority. The computer program described herein may comprise a priority limitation feature 40A, whereby a user may add or edit a list item and give it a new priority number and the computer program will automatically update the list order and each list items priority number. A priority limitation feature may allow for only one priority number “1” and therein change a previous priority number “1” list item to priority “2” in the event that the user added a new list item with a priority number “1,” or edited an existing list item to priority number “1.” All list item priorities in the list may be updated when a user adds a new list item or edits an existing list item priority. As shown in FIG. 2B, the list item priority numbers have been changed as a function of a user selecting the priority limitation feature as described herein.

A priority limitation feature may further provide a user with an interface to select or input a priority limitation range between a lower limitation priority number 44 and an upper limitation priority number 46, and a priority limitation cap 48 as shown in FIG. 2A. The computer program will allow for a number of list items between and including the upper and lower limitation priority numbers equal to the priority limitation cap. For example, a user may select a lower limitation priority number of 1, an upper limitation priority number of 5, and a priority limitation cap of one, whereby the priority limitation feature will allow for only a single list item with those priority numbers. Therefore, a user may have a list with two or more list items having a priority number of “6.” As shown in FIGS. 2A and 2B, the plurality of list items having a number “1” priority were updated as shown in FIG. 2B, wherein only a single list item has a priority between “1” and “4”. If a new list item were added to the list shown in FIG. 2B, with a priority of “1”, list item “Bananas” would have a new priority number of “2”, “Pears” a new priority of “3”, and so on. The priority limitation feature allows a user to set any number of priority limitation ranges and priority limitation caps, whereby the most recent entry will override previously submitted entries where there are overlaps in ranges.

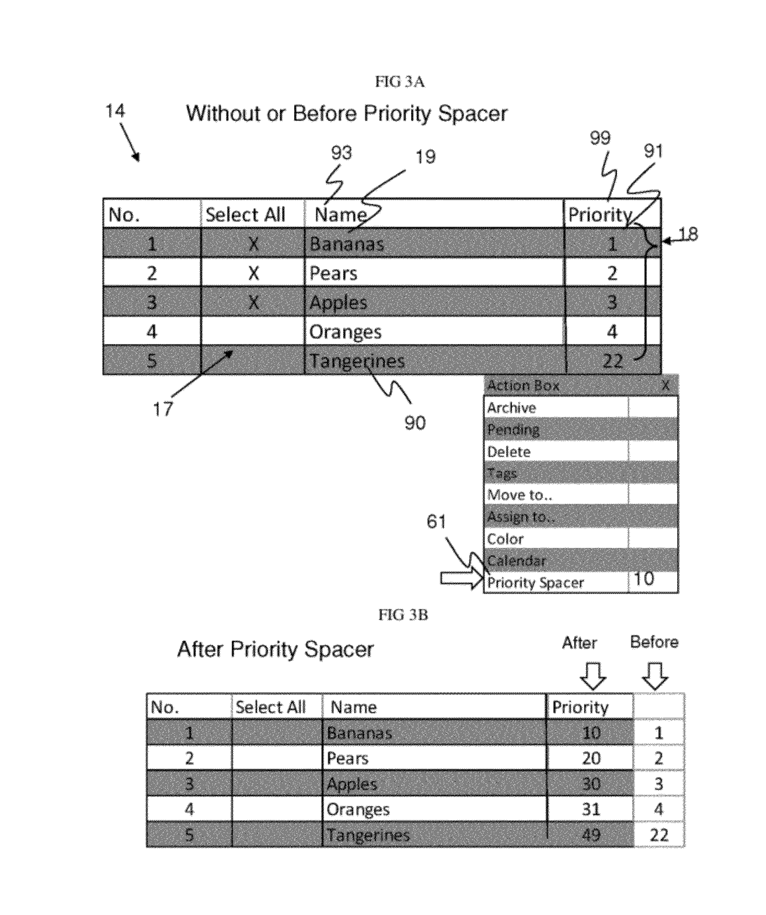

The computer program described herein may comprise a priority spacer feature 61, whereby a user may select any number of list items and increase their priority ranking by the product of the list item's priority number and the priority spacing number. As shown in FIG. 3A, a user has selected three of the list items from the electronic list, as indicated by the X's in the “Select All” field. The user has also selected a priority spacer feature from a pop-up field window and input a spacing number of ten. As shown in FIG. 3B, the selected list items' priorities have been increased by the product of their previous priority numbers and the spacing number. List items not selected prior to the priority spacer feature use maintain the same priority number difference between the next lower list item priority number. As shown in FIG. 3B list item “Oranges”, having a priority number of four prior to the priority spacer feature, has a priority number of thirty-one after the priority spacer feature. Likewise, list item “Tangerines”, having a priority number of twenty-two prior to the priority spacer feature has a priority number of forty-nine after the priority spacer feature. Priority numbers of list items not selected when a priority spacer feature is selected may be reprioritized according to the priority limitation feature as described herein. For example, if a user selects a list priority with a priority number of “2,” and selects a priority spacer of ten, and there exists a list item with a priority number of “20,”, the existing list item will have a new priority of “21” when a priority limitation range has been selected for this range with a priority cap of one. The priority spacer feature provides the option of creating more space between list item priorities and may be used in place, of or in conjunction with the priority limitation feature described herein.

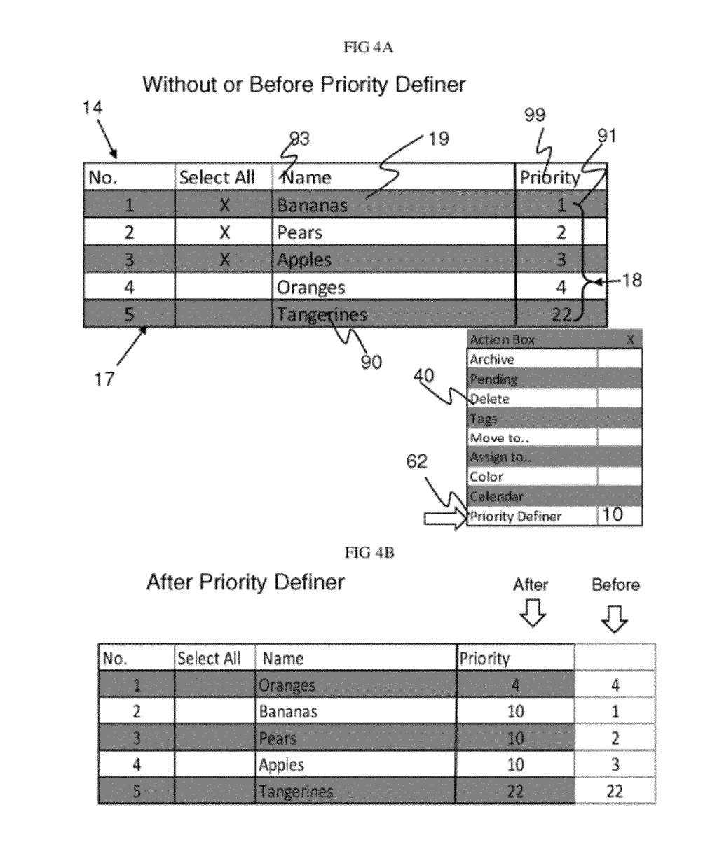

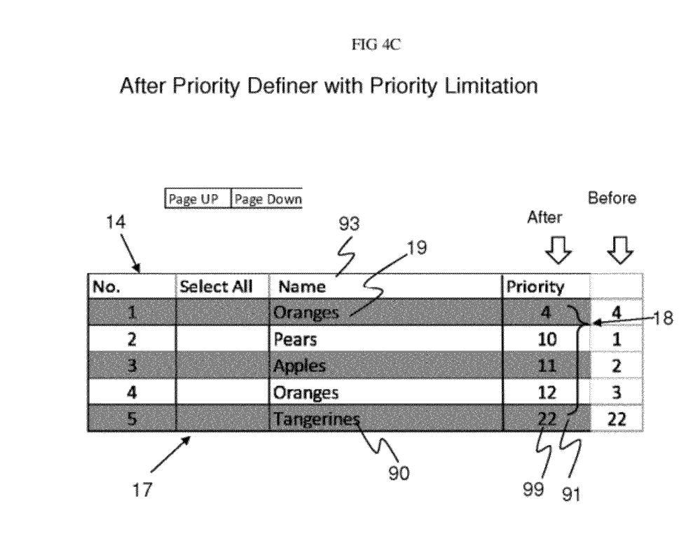

The computer program may also comprise a priority definer feature 62, whereby a user may select any number of list items and edit their priority numbers to newly defined priority numbers, as described hereafter. For example, as shown in FIG. 4A a user has selected three list items from the list, as indicated by the X's in the Select All field. The user selected the priority definer feature 62 and then input priority definer number 10, as shown in the pop-up window 40. As shown in FIG. 4B the three selected list items now all have a priority number of “10,” and list item “Oranges” has moved to the top of the priority list with a priority number of “4.” List item “Tangerines” did not have any change in priority number, as shown in FIG. 8B. If, however, the user had previously selected the priority limitation feature with priority limitation range including “10” through “12” and a priority limitation cap of one, the new list and priorities would be updated as shown in FIG. 4C. Therefore, as shown in FIG. 4C, the priorities selected and defined with a priority definer number of 10, have priority numbers “10,” “11,” and “12,” according to their previous priority ranking.

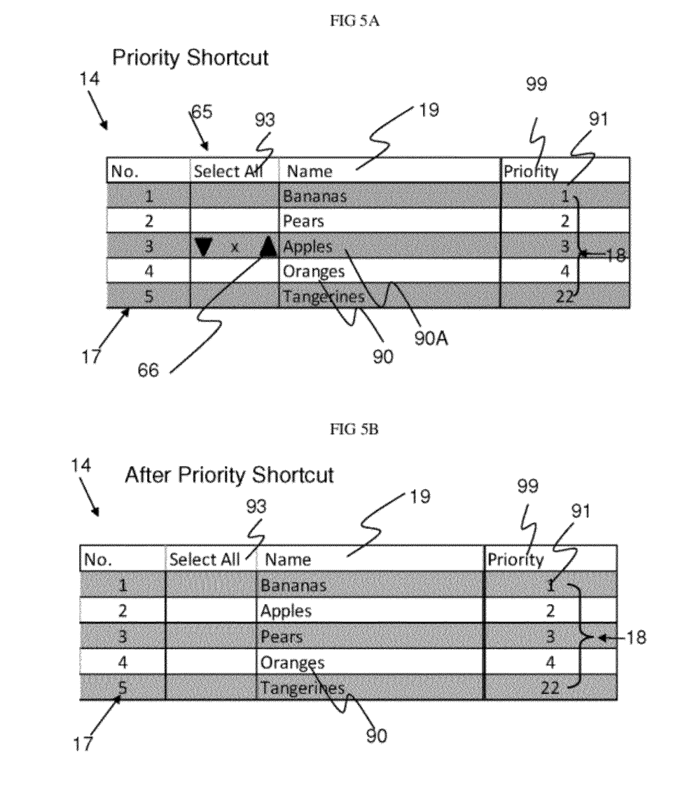

The computer program may also comprise a priority shortcut feature 65, whereby a user may select a priority shortcut feature 66 to move list items up or down. A priority shortcut feature 66 may be an arrow or some other icon that indicates movement of the list items as shown in FIG. 5A. For example, priority shortcut feature, such as up and down arrow may be displayed about each list item, such as within or connected with a list item field. The shortcut feature icon or icons may be displayed at all times or only when the user has selected the priority shortcut feature. In another embodiment, the priority shortcut feature pop-up, such as the arrows shown in FIG. 5A, may be displayed when a user selects a list item, as indicated by the X in the “Select All” field. For example, a user may click on a single list item and move it up or down by subsequently selecting the priority shortcut feature or by clicking on a priority shortcut feature. As shown in FIG. 5B, list item Apples 90A that was selected in FIG. 5A has been moved up, by the user selecting the up arrow. The other list items have automatically had their priority numbers updated by this action. In another embodiment, a user may select a plurality of list items and move the selected group up or down collectively by selecting a priority shortcut feature. In yet another embodiment, a user may select a list item or list items and then input a command through a keyboard, for example, to move list item or list items. For example, a user may select a list item and click on the up or down arrow on a keyboard to move the selected list item.

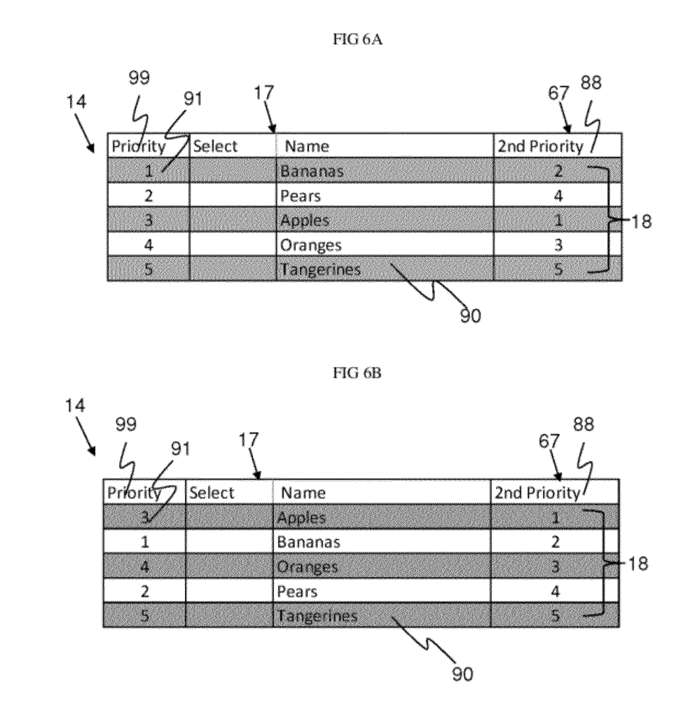

The computer program may also comprise a personal priority feature 67, whereby the electronic list may comprise a secondary priority number field 88, as shown in FIGS. 6A and 6B. This field may be used to set a personal or secondary priority to the list items without affecting the primary priority list. As shown in FIG. 6A, a user has set secondary priority numbers 18, to the list items and these priority numbers may be different from the primary priority numbers. A user may then select the secondary priority field, and sort by this field without affecting the primary priority numbers 18, as shown in FIG. 6B.

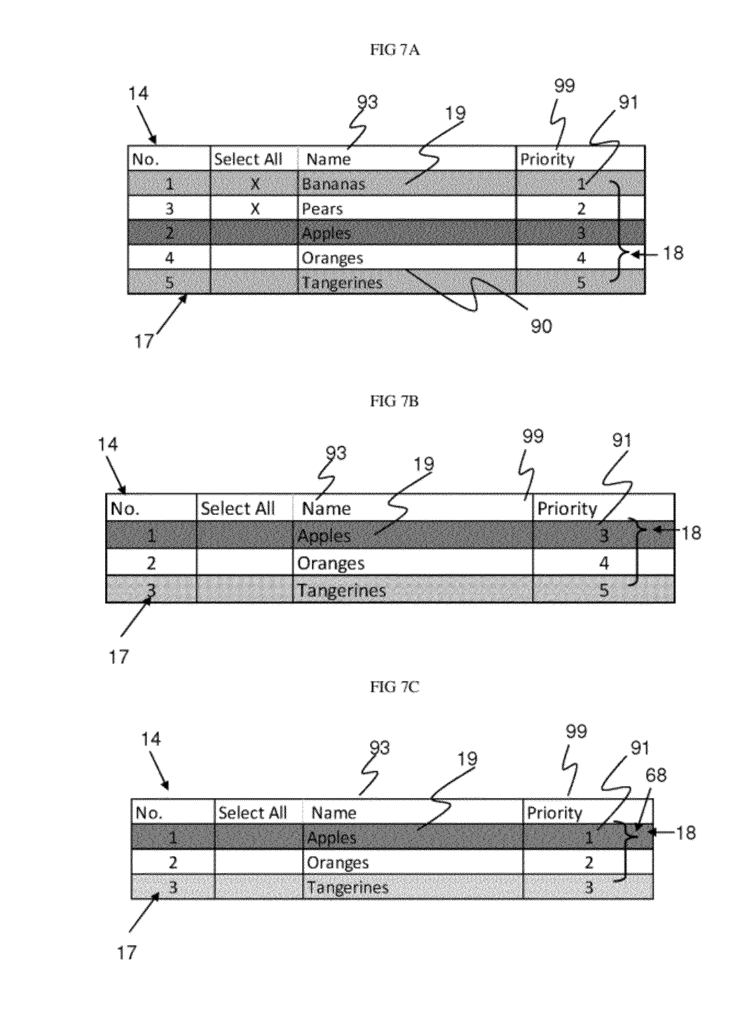

The computer program may also comprise a priority re-distribution feature, thereby allowing the user to choose to have priority numbers automatically updated when priority numbers have been edited in any way, including adding or deleting a new list item. As shown in FIG. 7A, a user has selected two list items, Bananas and Pears, as indicated by the X's in the Select All field. The user then deletes the two selected list items. Without the priority re-distribution feature selected, the two list items are removed, the list is re-ordered by moving list items up, however, the remaining list item priority numbers are not changed or updated, as shown in FIG. 7B. If, however, the user had selected the priority re-distribution feature, the priorities of the remaining list items priority numbers would be re-prioritized. List item “Pears” would become priority number “1” and list item “Oranges” would be become priority number “2” and so on.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combination and variations of this invention provided they come within the scope of the appended claims and their equivalents.

1. An electronic list priority management system comprising:
an electronic device having a display;
a computer program providing;
at least one working display;
user interface features; and
at least one advance priority management feature;
an electronic list comprising a plurality of electronic list items comprising;
at least one associated field having field data;
at least one priority field having a priority number; and
whereby a user may interface with the electronic device to input, delete, edit, or prioritize electronic list items, or may sort the electronic list by a field.

2. The electronic list priority management system of claim 1, further comprising a network and database, whereby said list items are displayed on a second user's working display.

3. The electronic list priority management system of claim 1, wherein the list is a task list having task list items comprising:
at least one priority field having a priority number; and
at least one task field that identifies a task,
wherein a user may sort the task list by any of the said fields.

4. The electronic list priority management system of claim 1, further comprising a network, whereby a plurality of users may interface with said electronic list priority management system.

5. The electronic list priority management system of claim 4, further comprising a database, whereby said electronic device may interface with said database, a plurality of users may interface with said electronic list priority management system, and electronic lists may be stored.

6. The electronic list priority management system of claim 1, whereby the working display is continuous work displayed.

7. The electronic list priority management system of claim 1, wherein the advance priority management feature comprises a priority limitation feature whereby a lower limitation priority number and upper priority limitation number, and a priory limitation cap are selected to limit list items having priority numbers between and including the lower and upper limitation priority numbers to no more than the priority limitation cap.

8. The electronic list priority management system of claim 1, wherein the advance priority management feature comprises a priority spacer feature whereby at least one list item priority number are changed to the product of the list item priority number and a priority spacer number.

9. The electronic list priority management system of claim 1, wherein the advance priority management feature comprises a priority definer feature, whereby at least one list item priority number is changed to a priority definer number.

10. The electronic list priority management system of claim 1, wherein the advance priority management feature comprises a priority default feature, whereby at least one added list item priority number is given a priority default number.

11. The electronic list priority management system of claim 1, wherein the advance priority management feature comprises a priority insert feature, whereby at least one new list item is added to the list by selecting a priority insert feature to add the new list.

12. The electronic list priority management system of claim 1, wherein the advance priority management feature comprises a priority shortcut feature, whereby a selected list item's priority number is changed by selecting a priority shortcut feature and moving the selected list item up or down in the list.

13. The electronic list priority management system of claim 1, wherein the advance priority management feature comprises a personal priority feature, wherein the plurality of list items comprise a secondary priority field, and whereby the list may be sorted by said secondary priority field.

14. The electronic list priority management system of claim 1, wherein the advance priority management feature comprises a priority re-distribution feature, whereby said priority numbers are automatically changed as a function of selected list items being removed from the list.

15. A method of prioritizing an electronic list comprising the steps of:
providing an electronic list management priority system comprising:
an electronic device having a display;
a computer program providing;
at least one working display;
user interface features; and
at least one advance priority management feature,
an electronic list comprising a plurality of electronic list items comprising;
at least one associated field having field data;
at least one priority field having a priority number; and
selecting an advance priority management features to reprioritize said priority numbers of list items.

16. The method of claim 15, wherein the list is a task list having task list items comprising:
at least one priority field having a priority number; and
at least one task field that identifies a task,
wherein a user may sort the task list by any of the said fields.

17. The method of claim 15, wherein a priority limitation feature is selected, whereby a lower limitation priority number and upper priority limitation number, and a priory limitation cap are selected to limit list items having priority numbers between and including the lower and upper limitation priority numbers to no more than the priority limitation cap.

18. A method of operating a computerized device user interface for determining the priority values of one or more items from a list of items, comprising:
automatically limiting the range of available priority inputs for the user, so that, given a plurality of items, a user may only enter the same priority values for a limited number of said items.

19. The method of claim 18, further providing a user entered priority limitation range so that said user may enter a lower bound priority number, and a higher bound priority number, and a priority limitation cap number so that only the priority limitation cap number of items from said plurality of items may be assigned the same priority number.

20. The method of claim 18, automatically providing numeric gaps or spaces between any previously assigned priority numbers of said one or more items from said list of items, so that any previously assigned item priority number is multiplied by a spacer number, thereby changing each previously assigned priority number to a new priority number times the spacer number, thereby creating numeric gaps between said previously assigned priority numbers so that new priority numbers with values between these gaps may be assigned to one or more items from said list of items.
